(19) United States
(12) Patent Application Publication
(10) Pub. No.: US 2022/0208156 A1
(43) Pub. Date: Jun. 30, 2022

(54) METHOD FOR GENERATING SONG MELODY AND ELECTRONIC DEVICE

(71) Applicant: BEIJING DAJIA INTERNET INFORMATION TECHNOLOGY CO., LTD., Beijing (CN)

(72) Inventors: Chun CHEN, Beijing (CN); Xiaokun MA, Beijing (CN); Xinyu ZHANG, Beijing (CN)

(21) Appl. No.: 17/504,096

(22) Filed: Oct. 18, 2021

(30) Foreign Application Priority Data
Dec. 30, 2020 (CN) 202011631078.5

(51) Int. Cl. G10H 1/00; G06F 3/0483; G06F 3/0484

(52) U.S. Cl. CPC G10H 1/0025; G06F 3/0482; G06F 3/04847; G06F 3/0483

(57) ABSTRACT

Provided is a method for generating a song melody. The method includes: displaying a melody configuration page; acquiring melody attribute information selected based on the melody configuration page; displaying a melody generation button in a triggerable state on the melody configuration page in response to selection of the melody attribute information being completed; displaying a candidate melody page in response to a triggering operation on the melody generation button; and determining one or more selected candidate melodies from at least one candidate melody as a target melody.

This application is based on and claims priority to Chinese Patent Application No. 202011631078.5, filed on Dec. 30, 2020, the disclosure of which is herein incorporated by reference in its entirety.

### TECHNICAL FIELD

The present disclosure relates to the field of internet technologies, and in particular, to a method for generating a song melody and an electronic device.

### BACKGROUND

With the development of internet technologies, there are more and more applications that support users in creating songs. Song creation includes lyric creation and melody creation.

### SUMMARY

The present disclosure provides a method for generating a song melody and an electronic device.

In one aspect of embodiments of the present disclosure, a method for generating a song melody is provided. The method includes:

displaying a melody configuration page;

acquiring melody attribute information selected based on the melody configuration page;

displaying a melody generation button in a triggerable state on the melody configuration page in response to selection of the melody attribute information being completed;

displaying a candidate melody page in response to a triggering operation on the melody generation button, wherein the candidate melody page displays at least one candidate melody that matches the melody attribute information; and

determining one or more selected candidate melodies from the at least one candidate melody as a target melody.

In another aspect of the embodiments of the present disclosure, an electronic device is provided. The electronic device includes:

at least one processor; and

a volatile or nonvolatile memory configured to store at least one instruction executable by the processor,

wherein the at least one processor, when executing the at least one instruction, is caused to perform:

displaying a melody configuration page;

acquiring melody attribute information selected based on the melody configuration page;

displaying a melody generation button in a triggerable state on the melody configuration page in response to selection of the melody attribute information being completed;

displaying a candidate melody page in response to a triggering operation on the melody generation button, wherein the candidate melody page displays at least one candidate melody that matches the melody attribute information; and

determining one or more selected candidate melodies from the at least one candidate melody as a target melody.

In another aspect of the embodiments of the present disclosure, a non-volatile computer-readable storage medium storing at least one instruction therein is provided. The at t least one instruction, when loaded and executed by a processor of an electronic device, causes the electronic device to perform:

displaying a melody configuration page;

acquiring melody attribute information selected based on the melody configuration page;

displaying a melody generation button in a triggerable state on the melody configuration page in response to selection of the melody attribute information being completed;

displaying a candidate melody page in response to a triggering operation on the melody generation button, wherein the candidate melody page displays at least one candidate melody that matches the melody attribute information; and

determining one or more selected candidate melodies from the at least one candidate melody as a target melody.

### BRIEF DESCRIPTION OF THE DRAWINGS

FIG. 1 is a diagram of an application environment of a method for generating a song melody according to an exemplary embodiment of the present disclosure.

FIG. 2 is a flowchart of a method for generating a song melody according to an exemplary embodiment of the present disclosure.

FIG. 3 is a schematic diagram of a melody configuration page according to an exemplary embodiment of the present disclosure.

FIG. 4 is a flowchart showing a generation progress of a song melody according to an exemplary embodiment of the present disclosure.

FIG. 5 is a schematic diagram showing a generation progress of a song melody according to an exemplary embodiment of the present disclosure.

FIG. 6 is a schematic diagram showing a candidate melody page according to an exemplary embodiment of the present disclosure.

FIG. 7 is a flowchart of a method for generating a song melody according to an exemplary embodiment of the present disclosure.

FIG. 8 is a block diagram of an apparatus for generating a song melody according to an exemplary embodiment of the present disclosure.

FIG. 9 is a block diagram of an electronic device according to an exemplary embodiment of the present disclosure.

### DETAILED DESCRIPTION

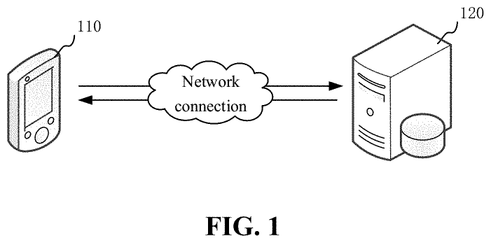

A method for generating a song melody provided by the present disclosure may be applied to an application environment shown in FIG. 1. A terminal 110 interacts with a server 120 through a network. In some embodiments, the terminal 110 is any one of a personal computer, a notebook computer, a smartphone, a tablet computer, and a portable wearable device. In some embodiments, the server 120 is implemented as an independent server or a server cluster composed of a plurality of servers. An application that supports a song melody generating function is installed in the terminal 110, and the application is a social application, a short-video application, an instant messaging application, a music creation application, or the like. The song melody generating function is deployed in these applications in the form of a plug-in, an applet, or the like. The terminal 110 provides a user with a song melody creation page through the application, such that the user can perform operations such as configuring melody attribute information, auditioning candidate melodies, and selecting a target melody from the candidate melodies on the song melody creation page. An intelligent melody generation logic is deployed in the server 120, and the melody generation logic is implemented based on a deep learning model, a search algorithm, or the like. The deep learning model is any model configured to determine the candidate melody, such as a linear model, a neural network model, or a support vector machine, and the search algorithm is sequential search, binary search, or the like.

In some embodiments, the terminal 110 displays a melody configuration page, and acquires melody attribute information selected based on the melody configuration page. The terminal 110 displays a melody generation button on the melody configuration page in response to selection of the melody attribute information being completed. The terminal 110 sends a song melody generation request carrying the melody attribute information to the server 120 in response to a triggering operation on the melody generation button. The server 120 determines at least one candidate melody that matches the melody attribute information based on the melody generation logic and sends the at least one candidate melody to the terminal 110. The terminal 110 displays a candidate melody page, such that the user can audition the at least one candidate melody and select one or more from the at least one candidate melody as a target melody.

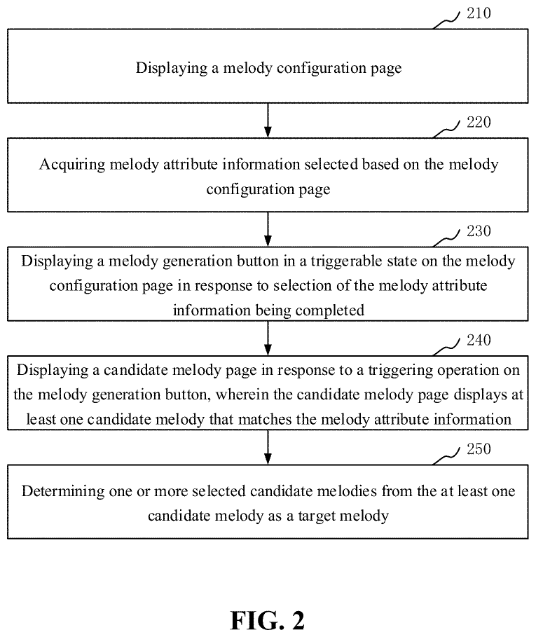

FIG. 2 is a flowchart of a method for generating a song melody according to an exemplary embodiment. In some embodiments, the method for generating the song melody is applied to a terminal and includes the followings.

In 210, a melody configuration page is displayed.

In 220, melody attribute information selected based on the melody configuration page is acquired.

Melody is a primary element of music and refers to an organized and rhythmic sequence formed by an artistic conception of several musical sounds. Melody is a combination of many basic elements of music, such as mode, rhythm, beat, and timbre performance methods. Melody attributes are used to reflect categories of the basic elements of music, and may be classified in multiple levels. For example, the first-level melody attributes include pitch, style, and rhythm. The first-level melody attribute “pitch” may further include second-level melody attributes of tenor, baritone, soprano, mezzo-soprano, and the like. The melody attribute information is used to reflect the user's expectations for the melody style of a song, and there is at least one piece of melody attribute information.

In some embodiments, after the user triggers an operation for creating a song melody, the terminal displays the melody configuration page on which an attribute configuration area is displayed. The user can configure desired melody attribute information based on the attributes displayed on the attribute configuration area. In some embodiments, the attribute configuration area displays at least one melody attribute and attribute information corresponding to the melody attribute. The attribute information of each melody attribute is displayed in the attribute configuration area in the form of a list, a button, or the like, such that the user can configure the melody attribute information by a drop-down menu of the list, clicking the button, or the like.

In some embodiments, the melody configuration page is configured with a material uploading area. The terminal can acquire materials uploaded by the user from the material uploading area. The materials include sound clips, songs, videos, pictures, or the like. The terminal acquires the melody attribute information by intelligently recognizing the materials uploaded by the user based on a deep learning model and other methods. In some embodiments, the deep learning model is a classification model that is adopted to classify and recognize the materials uploaded by the user, and an acquired category is used as the melody attribute information. The deep learning model in embodiments of the present disclosure has been trained using several material samples and can detect and recognize the materials uploaded by the user.

In some embodiments, the melody configuration page is configured with an attribute input area. A text input box is displayed in the attribute input area. The user may manually input text information in the text input box, such that the terminal selects the melody attribute information from a plurality of pieces of predefined melody attribute information based on the text information. For example, the terminal semantically understands the text information based on the deep learning model to determine the user's search intention, and then, extracts keywords from the text information and performs alignment process based on the keywords to acquire the selected melody attribute information

In some embodiments, the melody configuration page is configured with an attribute recommendation area. The attribute recommendation area displays a plurality of pieces of recommended attribute information. The recommended attribute information is acquired by a recommending system that performs a recommendation based on a recommendation logic. The recommendation logic is deployed based on a similarity between a user account and the melody attribute information, the searching popularity of the melody attribute information, or the like. For example, the recommended attribute information is melody attribute information with a larger search volume or higher popularity, melody attribute information more compatible with behavior data of the user account, or the like. The terminal displays the recommended attribute information in the attribute recommendation area for the user to read and select. The terminal can acquire the selected melody attribute information in response to a selecting operation on one or more pieces of recommended attribute information in the attribute recommendation area.

In some embodiments, the melody configuration page is configured with a history area. The history area displays history attribute information that the user account has searched for. The terminal acquires the selected melody attribute information in response to a selecting operation on one or more pieces of history attribute information in the history area.

In 230, a melody generation button is displayed in a triggerable state on the melody configuration page in response to selection of the melody attribute information being completed.

The user may interact with the melody generation button to trigger intelligent generation of the song melody based on the selected melody attribute information. The melody generation button has an un-triggerable state in which the melody generation button cannot be triggered and a triggerable state in which the melody generation button can be triggered. The melody generation button switches its state in response to an operation on itself. The melody generation button is not limited to being displayed at any position of the melody configuration page using a fixed control, or being flexibly presented on the melody configuration page using a hover button or the like.

In some embodiments, the completion of the selection of the melody attribute information is determined in response to an adding completion instruction of the user, or is determined by the terminal per se after the user selects the melody attribute information. In response to the terminal determining that the selection of the melody attribute information is completed, the melody generation button on the melody configuration page switches from the un-triggerable state to the triggerable state to prompt the user to proceed to the next operation.

Further, display styles of the melody generation button in the triggerable state and the un-triggerable state are different. For example, the melody generation button in the triggerable state is rendered in colors, and the melody generating button in the un-triggerable state is rendered in grey. By configuring different display styles for the melody generation button, the user can be given obvious visual reminders, which improves the man-machine reaction efficiency.

In 240, a candidate melody page is displayed in response to a triggering operation on the melody generation button, wherein the candidate melody page displays at least one candidate melody that matches the melody attribute information.

In some embodiments, the terminal sends a melody generation request to a server in response to the triggering operation on the melody generation button. The melody generation request carries the selected melody attribute information to request the server to generate a candidate melody that matches the melody attribute information. The server sends the candidate melody to the terminal after determining the candidate melody based on a melody generation logic. The terminal displays the candidate melody sent by the server on the candidate melody page.

In 250, one or more selected candidate melodies from the at least one candidate melody are determined as a target melody.

There may be one or more candidate melodies. In the case that there are a plurality of candidate melodies, the user can select one or more of the candidate melodies as the target melody; and in the case that there is one candidate melody, the target melody selected by the user is the same as the candidate melody.

In some embodiments, the candidate melody is acquired as follows. A corresponding relationship between the melody attribute information and the melody is configured in the server. Upon receiving the melody generation request, the server retrieves at least one candidate melody that matches the selected melody attribute information based on the corresponding relationship between the melody attribute information and the melody.

In some embodiments, the corresponding relationship between the melody attribute information and the melody is obtained as follows. A plurality of melody clips are acquired. The plurality of melody clips are acquired by one or more methods of acquiring from existing song melodies, acquiring from melodies self-created by the user, splicing the existing melodies, or the like. The melody attribute information of each melody clip is acquired by analyzing and processing each melody clip based on the deep learning model. A melody library corresponding to the melody attribute information is created; or each melody clip is labeled with a corresponding melody attribute information tag, such that a corresponding relationship between the melody clip and the melody attribute information is formed.

In some embodiments, there are a plurality of pieces of melody attribute information. The melody that matches any piece of melody attribute information is determined as the candidate melody, or the melody that matches all pieces of melody attribute information may is determined as the candidate melody.

In some embodiments, the priority of each melody attribute is set. The candidate melodies are ranked according to the priorities of the melody attributes. For example, the higher the priority of the melody attribute is, the higher the ranking of the corresponding candidate melody is.

The above-mentioned method for determining the candidate melody can also be acquired by the terminal. Determining the candidate melody by the server and determining the candidate melody by the terminal differ only in an execution subject, implementation principles, and processes of which are similar.

In the method for generating the song melody, by supporting the user in self-configuring the melody attribute information through providing a melody configuration page for the user's selection, displaying the melody generation button on the melody configuration page in the triggerable state in response to configuration of the melody attribute information being completed, and displaying the candidate melody page in response to the user's triggering operation on the melody generation button, the song melody can be intelligently generated based on the melody attribute information. In this way, the user can be assisted in quickly completing the creation of the song melody that is suitable to his/her need or expectation. In addition, a user without professional knowledge of music can easily create a personalized song melody, and the song melody creation efficiency is greatly improved.

In some embodiments, a song theme is displayed on the melody configuration page. In 240, displaying the candidate melody page in response to the triggering operation on the melody generation button includes: acquiring, in response to the triggering operation on the melody generation button, at least one candidate melody that matches both the song theme and the melody attribute information; and displaying the candidate melody page.

The song theme indicates the type of the content and reflects the user's expectations for the core content of lyrics, and there is at least one song theme, such as youth, humor, love, praise, campus, and the like. Multi-level song themes may be pre-defined. For example, first-level song themes include youth, humor, love, praise, and campus. The first-level song theme “Youth” includes second-level song themes such as the girl next door, post-70s, and post-80s.

In some embodiments, the song theme is acquired based on the text information manually input by the user. For example, a song theme that matches the text information is searched from the plurality of pre-defined song themes based on the manually input text information. In some embodiments, the terminal searches for the song theme containing the text information from the pre-defined song themes based on a search algorithm. Or, the input text information is converted into a corresponding feature vector in real time; a similarity between the feature vector of the text information and a feature vector of each song theme is calculated based on the deep learning model, and a preset number of song themes with the highest similarity is selected, in which the similarity is characterized by a cosine similarity, a Hamming distance, a Mahalanobis distance, or the like.

In some embodiments, the song theme is a selected theme from recommended themes. The recommended themes are acquired by a recommending system based on a recommendation logic. The recommendation logic is deployed based on a similarity between the user account and the song theme, the searching popularity of the song theme, or the like. For example, the song theme is a theme with a larger search volume or higher popularity, a theme more compatible with behavior data of the user account, or the like.

In some embodiments, the song theme is acquired by recognizing the materials uploaded by the user based on the deep learning model. The materials uploaded by the user include pictures, music, characters, videos, or the like. The deep learning model acquires the song theme by detecting and recognizing the materials uploaded by the user.

In some embodiments, in the case that the melody configuration page contains the song theme, the terminal sends the melody generation request to the server in response to the triggering operation on the melody generation button, the melody generation request carrying the song theme and selected melody attribute information. The server determines a matched melody based on the melody attribute information. For the specific implementation in which the server determines the melody that matches the melody attribute information, reference can be made to the foregoing embodiments, and details are not described herein. Then, the server adjusts the matched melody based on the song theme, for example, adjusts duration, pitches, and rhythms of phonemes in the melody based on the song theme, and determines the adjusted melody as the candidate melody. The server sends the candidate melody to the terminal. The terminal displays the candidate melody sent by the server on the candidate melody page.

In embodiments of the present disclosure, by allowing the user to self-configure the melody attribute information and the song theme, the terminal can acquire the matched candidate melody based on the song theme and the melody attribute information, such that the user can be assisted in quickly acquiring a song melody that matches a desired style, which improves the human-machine reaction efficiency.

In some embodiments, in 220, acquiring the melody attribute information selected based on the melody configuration page includes: acquiring melody attribute information corresponding to each melody attribute through an attribute selection control corresponding to each melody attribute.

In some embodiments, the melody configuration page includes an attribute selection control corresponding to each melody attribute. The terminal acquires the selected melody attribute information in response to a triggering operation on the attribute selection control.

In some embodiments, display styles of the attribute selection control in a selected state and a deselected state are different. For example, the attribute selection control in the selected state is rendered in colors, and the attribute selection control in the deselected state is rendered in grey. By configuring different display styles for the attribute selection control, the user can be given obvious visual reminders, which improves the human-machine reaction efficiency.

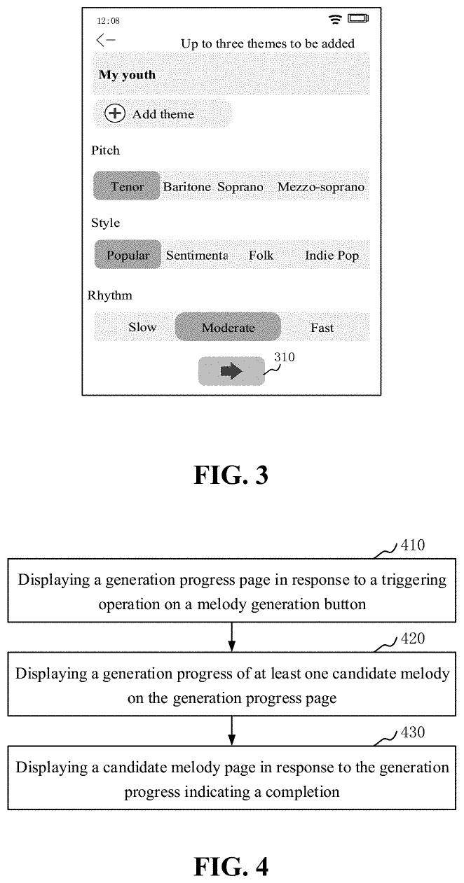

For example, as shown in FIG. 3, the melody configuration page includes the following melody attributes: pitch, style, and rhythm. Under each melody attribute, a plurality of corresponding attribute selection controls are displayed. For example, under pitch, four attribute selection controls of tenor, baritone, soprano, and mezzo-soprano are displayed. Under Style, four attribute selection controls of popular, sentimenta, folk and Indie pop are displayed. Under Rhythm, three attribute selection control of slow, moderate, and fast are displayed. The user may perform a triggering operation on the attribute selection control, such that the terminal can acquire the melody attribute information. Referring to FIG. 3, the selected melody attribute information is pitch-tenor, style-popular, and rhythm-moderate.

In addition, a melody generation button 310 is also displayed on the melody configuration page. In response to selection of the melody attribute information being completed, the terminal switches the melody generation button 310 from the un-triggerable state to the triggerable state to prompt/enable the user to perform the next operation.

In embodiments of the present disclosure, by displaying the melody attribute information in the form of control on the melody configuration page, the user can be given an obvious visual reminder, such that the user can quickly configure the desired melody attribute information in a simple way, which improves the man-machine reaction efficiency.

In some embodiments, as shown in FIG. 4, in 240, displaying the candidate melody page in response to the triggering operation on the melody generation button includes the followings.

In 410, a generation progress page is displayed in response to a triggering operation on the melody generation button.

In 420, a generation progress of at least one candidate melody is displayed on the generation progress page.

In 430, the candidate melody page is displayed in response to the generation progress indicating a completion.

In some embodiments, the terminal sends a melody generation request to the server after detecting the triggering operation on the melody generation button, to request the server to generate at least one candidate melody based on the selected melody attribute information. The implementation of generating the candidate melody may refer to the foregoing embodiments, and details are not described herein. The server sends a generation progress of the candidate melody to the terminal in real time. The generation progress is displayed by the terminal in the form of a pop-up window, a sub-page, a preset position on the melody configuration page, or the like. In response to the generation progress indicating a completion, the terminal acquires the candidate melody from the server and displays the candidate melody page.

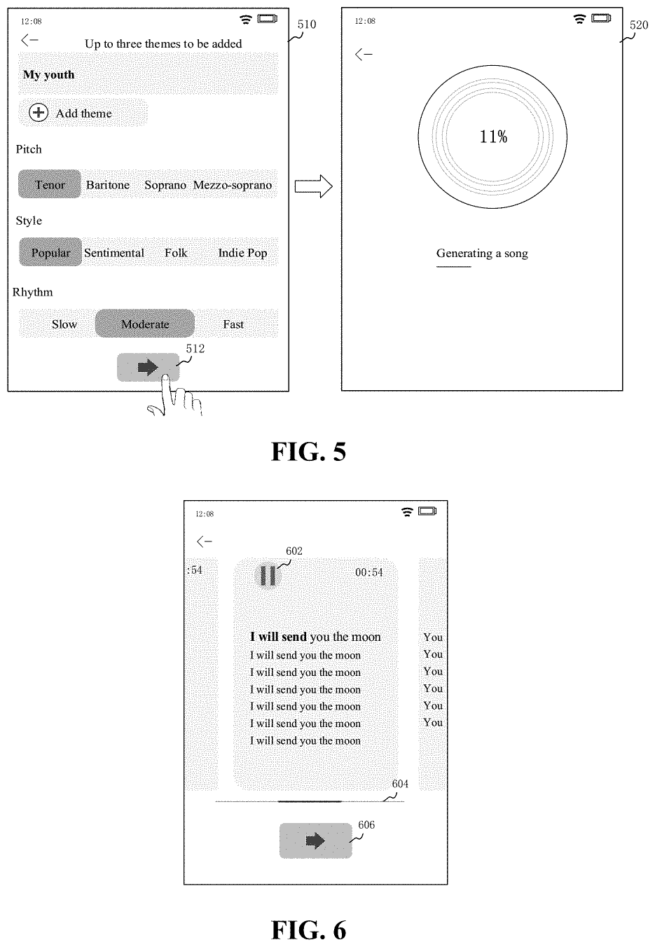

For example, as shown in FIG. 5, the terminal displays a melody generation button 512 in a triggerable state on a melody configuration page 510 in response to selection of the melody attribute information being completed. In response to a triggering operation on the melody generation button 512, the terminal sends a melody generation request to the server and displays a generation progress page 520 of the candidate melody. The terminal acquires the generation progress from the server and displays the generation progress on the generation progress page 520. For example, a text “generating a song” may be shown to indicate that the song generation is in progress. Further, the extent of the completion of the song generation is shown and displayed as a percentage of completion for example.

In embodiments of the present disclosure, by showing the user the generation progress of the candidate melody in real time, the user can intuitively understand the generation progress of the song melody. Therefore, the operability in generating the melody is improved and the melody generation function is made more comprehensive.

In some embodiments, the candidate melody page includes at least one subpage. At least one candidate melody is in one-to-one correspondence with the at least one subpage. Displaying the candidate melody page includes: displaying a subpage of a first candidate melody on the candidate melody page. The first candidate melody is therefore a current candidate melody.

The subpage refers to presenting each candidate melody on a separate page, or presenting respective candidate melodies in the form of cards on the same page, or the like. In some embodiments, in response to there being a plurality of candidate melodies, the terminal displays the plurality of candidate melodies in subpages. Each subpage displays the corresponding candidate melody. The user can control switching between the subpages of the candidate melodies by sliding, clicking a designated control, clicking a button, or the like.

In some embodiments, the terminal displays melody-related information of the candidate melodies in the form of a list or the like, such that the user can directly skip to the corresponding candidate melody by selecting the melody-related information in the list. Alternatively, the list may be presented in the form of a hidden sidebar, a drop-down menu, or the like.

In some embodiments, the terminal displays information, such as the total number of the plurality of candidate melodies and ranking of the current candidate melody in all the candidate melodies on the candidate melody page. For example, the total number of the plurality of candidate melodies is displayed, and the serial number of the current candidate melody is displayed; or, a prompt bar corresponding to each candidate melody is displayed, and the prompt bar corresponding to the current candidate melody is highlighted.

In some embodiments, a melody determination button is displayed on the candidate melody page. The melody determination button is configured to determine the first candidate melody that is currently selected as the target melody. The terminal determines the first candidate melody as the target melody in response to a triggering operation on the melody determination button.

FIG. 6 exemplarily shows a schematic diagram of a candidate melody page. As shown in FIG. 6, a plurality of candidate melodies are presented in the form of cards (subpages) on the candidate melody page. The terminal presents a subpage of a second candidate melody adjacent to the subpage of the first candidate melody in response to a melody switching operation (e.g., sliding to left or right) performed by the user.

As shown in FIG. 6, the candidate melody page further displays a playback control button 602. The playback control button 602 is configured to control playback of the first candidate melody. The terminal stops playing the candidate melody or starts to play the candidate melody in response to a triggering operation on the playback control button 602. The candidate melody page further displays a sliding prompt bar 604. The sliding prompt bar 604 slides in the same direction as the switching operation together with the user's melody switching operation. The candidate melody page further displays a melody determination button 606. The terminal determines the first candidate melody (i.e., the current candidate melody) as a target melody in response to a triggering operation on the melody determination button 606. The candidate melody page further displays melody duration of the first candidate melody, e.g., 00:54 as shown in FIG. 6.

In embodiments of the present disclosure, in response to there being a plurality of candidate melodies, by displaying the candidate melodies in subpages, it is convenient for the user to audition each candidate melody, which improves the use convenience for the user. By displaying prompt information of melody switching on the candidate melody page, it is convenient for the user to quickly acquire the total number of the candidate melodies and ranking of the first candidate melody in all the candidate melodies.

In some embodiments, the candidate melody page further displays a candidate lyric. The candidate lyric is acquired from a pre-deployed lyric library corresponding to the candidate melody. The terminal configures a corresponding lyric for the song melody. The terminal finds the candidate lyric corresponding to the candidate melody in the lyric library after the candidate melody is determined, and displays the candidate lyric on the candidate melody page.

In some embodiments, the candidate lyric is acquired based on the song theme described in the foregoing embodiments. The terminal sends a lyric generation request to the server in response to a triggering operation on the melody generation button. The lyric generation request carries the song theme. The server acquires the candidate lyric that matches the song theme based on a lyric generation logic and sends the candidate lyric to the terminal, such that the terminal displays the candidate lyric on the candidate melody page.

In some embodiments, the candidate lyric that matches the song theme is acquired as follows. A corresponding relationship between the song theme and the lyric is configured in the server. After receiving the lyric generation request, the server retrieves at least one candidate lyric from the corresponding relationship between the song theme and the lyric. The corresponding relationship between the song theme and the lyric is obtained by followings. A plurality of lyrics are acquired in advance. The plurality of lyrics are acquired by one or more methods, such as collecting lyrics in existing songs, self-creating lyrics by the user, and combining words and phrases of the lyrics by a deep learning model. The song theme of each lyric is acquired by analyzing and processing each lyric based on a text theme model. A lyric library corresponding to the song theme is created, and the lyrics are stored in the lyric library corresponding to the song theme. Or, each lyric is labeled with a corresponding song theme tag to form the corresponding relationship between the song theme and the lyrics.

In embodiments of the present disclosure, the candidate lyric is correspondingly acquired while the candidate melody is acquired, and the candidate lyric and the candidate melody are displayed on the terminal at the same time. The terminal presents a complete song form to the user, which helps the user to intelligently create a complete song, greatly improves the efficiency of song creation, and reduces the requirement for professional knowledge of music in song creation, thereby improving the man-machine reaction efficiency.

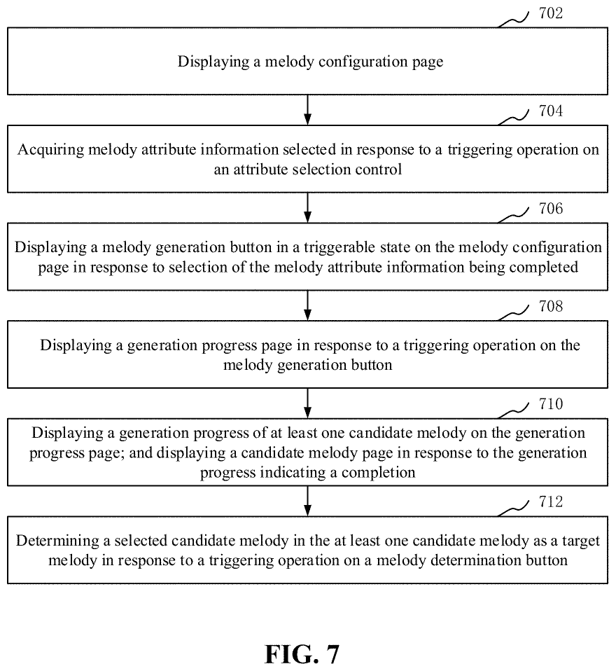

FIG. 7 is a flowchart of another method for generating a song melody according to an exemplary embodiment. As shown in FIG. 7, the method for generating the song melody is executed by a terminal and includes the followings.

In 702, a melody configuration page is displayed. Referring to FIG. 3, the melody configuration page may include at least one melody attribute and an attribute selection control corresponding to each melody attribute.

In 704, selected melody attribute information is acquired in response to a triggering operation on the attribute selection control.

In 706, a melody generation button on the melody configuration page is displayed in a triggerable state in response to selection of the melody attribute information being completed. Referring to FIG. 3, the melody generation button 310 is changed from an un-triggerable state to the triggerable state in response to the selection of the melody attribute information being completed.

In 708, a generation progress page is displayed in response to a triggering operation on the melody generation button. FIG. 5 exemplarily shows a schematic diagram of a generation progress page 520 of a candidate melody.

In 710, a generation progress of at least one candidate melody is displayed on the generation progress page, and a candidate melody page is displayed in response to the generation progress indicating a completion.

The method for determining the candidate melody may refer to the foregoing embodiments, and details are not described herein. Referring to FIG. 6 and the corresponding embodiments, the candidate melody page may be displayed in subpages. The candidate melody page may further include contents, such as a sliding prompt bar, a melody determination button, melody duration, and a playback control button.

In 712, a selected candidate melody in the at least one candidate melody is determined as a target melody in response to a triggering operation on the melody determination button.

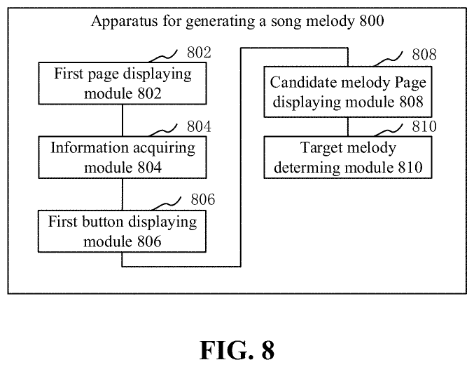

FIG. 8 is a block diagram of an apparatus 800 for generating a song melody according to an exemplary embodiment. Referring to FIG. 8, the apparatus 800 includes a first page displaying module 802, an information acquiring module 804, a first button displaying module 806, a candidate melody page displaying module 808, and a target melody determining module 810.

The first page displaying module 802 is configured to display a song melody configuration page; the information acquiring module 804 is configured to acquire melody attribute information selected based on the melody configuration page; the first button displaying module 806 is configured to display a melody generation button in a triggerable state on the melody configuration page in response to selection of the melody attribute information being completed; the candidate melody page displaying module 808 is configured to display a candidate melody page in response to a triggering operation on the melody generation button, wherein the candidate melody page displays at least one candidate melody that matches the melody attribute information; and the first target melody determining module 810 is configured to determine one or more selected candidate melodies from the at least one candidate melody as a target melody.

In some embodiments, a song theme is displayed on the melody configuration page; and the candidate melody page displaying module 808 includes: a candidate melody page displaying unit configured to acquire, in response to the triggering operation on the melody generation button, at least one candidate melody that matches both the song theme and the melody attribute information; and a first page displaying unit configured to display the candidate melody page.

In some embodiments, the candidate melody page comprises at least one subpage in one-to-one correspondence with the at least one candidate melody; and the first page displaying module 802 is configured to display a subpage of a first candidate melody on the candidate melody page.

In some embodiments, the apparatus 800 further includes a switching module configured to display, in response to a switching operation on the subpage page of the first candidate melody, a subpage of a second candidate melody adjacent to the subpage of the first candidate melody.

In some embodiments, the apparatus 800 further includes a sliding prompt bar displaying module and a controlling module. The sliding prompt bar displaying module is configured to display a sliding prompt bar on the candidate melody page; and the controlling module is configured to control the sliding prompt bar to slide in a switching direction of the switching operation in response to a switching operation on the subpage of the first candidate melody.

In some embodiments, the apparatus 800 further includes a second button displaying module and a second target melody determining module. The first button displaying module is configured to display a melody determination button on the candidate melody page; and the second target melody determining module is configured to determine a selected candidate melody as the target melody in response to a triggering operation on the melody determination button.

In some embodiments, the melody configuration page includes a plurality of melody attributes and attribute selection controls corresponding to the melody attributes; and the information acquiring module 804 is configured to acquire melody attribute information corresponding to the melody attribute in response to a triggering operation on the attribute selection control corresponding to the melody attribute.

In some embodiments, the candidate melody page displaying module 808 includes a second page displaying unit, a progress acquiring unit, and a second melody acquiring unit. The second page displaying unit is configured to display a generation progress page in response to the triggering operation on the melody generation button; the progress acquiring unit is configured to display a generation progress of the at least one candidate melody on the generation progress page; and the second melody acquiring unit is configured to display the candidate melody page in response to the generation progress indicating a completion.

In some embodiments, the apparatus 800 further includes a lyrics acquiring module and a lyrics displaying module. The lyrics acquiring module is configured to acquire at least one candidate lyric corresponding to the at least one candidate melody in response to the triggering operation on the melody generation button; and the lyrics displaying module is configured to display the at least one candidate lyric on the candidate melody page.

Regarding the apparatus in the foregoing embodiments, the specific manner in which each module performs operations has been described in detail in the method embodiments, and will not be elaborated herein.

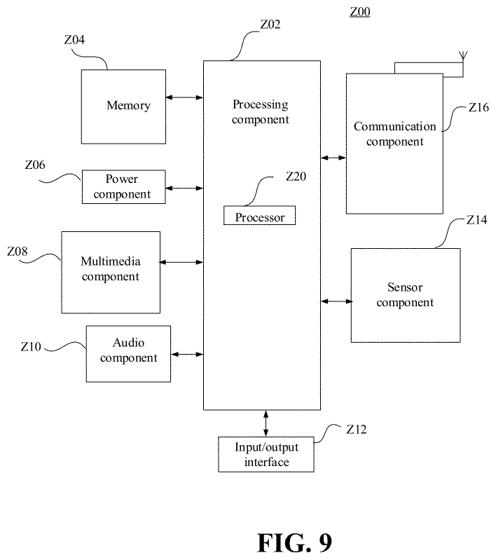

FIG. 9 is a block diagram of an electronic device ZOO for generating a song melody according to an exemplary embodiment. For example, the electronic device ZOO may be a mobile phone, a computer, a digital broadcasting terminal, a message transceiving device, a game console, a tablet device, a medical device, a fitness device, a personal digital assistant, or the like.

Referring to FIG. 9, the electronic device Z00 may include one or more of a processing component Z02, a memory Z04, a power component Z06, a multimedia component Z08, an audio component Z10, an input/output (I/O) interface Z12, a sensor component Z14, and a communication component Z16.

The processing component Z02 typically controls the overall operations of the electronic device Z00, such as the operations associated with display, telephone calls, data communications, camera operations, and recording operations. The processing component Z02 may include at least one processor Z20. The at least one processor Z20, when executing at least one instruction, is caused to perform the method for generating a song melody described above.

In addition, the processing component Z02 may include one or more modules that facilitate the interaction between the processing component Z02 and other components. For example, the processing component Z02 may include a multimedia module to facilitate the interaction between the multimedia component Z08 and the processing component Z02.

The memory Z04 is configured to store various types of data to support the operation of the electronic device Z00. Examples of such data include instructions, contact data, phonebook data, messages, pictures, video, or the like in any applications or methods operated on the electronic device Z00. The memory Z04 may be implemented using any type of volatile or non-volatile memory devices, or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic, or optical disk.

The power component Z06 provides power to various components of the electronic device Z00. The power component Z06 may include a power management system, one or more power sources, and any other components associated with the generation, management, and distribution of power in the electronic device Z00.

The multimedia component Z08 includes a screen providing an output interface between the electronic device Z00 and the user. In some embodiments, the screen may include a liquid crystal display (LCD) and a touch panel (TP). In the case that the screen includes the touch panel, the screen may be implemented as a touch screen to receive input signals from the user. The touch panel includes one or more touch sensors to sense touches, slips, and gestures on the touch panel. The touch sensors may not only sense a boundary of a touch or slip action, but also sense a period of time and a pressure associated with the touch or slip action. In some embodiments, the multimedia component Z08 includes a front camera and/or a rear camera. The front camera and/or the rear camera may receive an external multimedia datum while the electronic device Z00 is in an operation mode, such as a photographing mode or a video mode. Each of the front camera and the rear camera may be a fixed optical lens system or have focus and optical zoom capability.

The audio component Z10 is configured to output and/or input audio signals. For example, the audio component Z10 includes a microphone (MIC) configured to receive an external audio signal in response to the electronic device Z00 being in an operation mode, such as a call mode, a recording mode, and a voice recognition mode. The received audio signal may be further stored in the memory Z04 or transmitted via the communication component Z16. In some embodiments, the audio component Z10 further includes a speaker to output audio signals.

The I/O interface Z12 provides an interface between the processing component Z02 and peripheral interface modules, such as a keyboard, a click wheel, buttons, and the like. The buttons may include, but are not limited to, a home button, a volume button, a starting button, and a locking button.

The sensor component Z14 includes one or more sensors to provide status assessments of various aspects of the electronic device Z00. For example, the sensor component Z14 may detect an on/off status of the electronic device Z00, relative positioning of components, e.g., the display and the keypad, of the electronic device Z00, a change in position of the electronic device Z00 or a component of the electronic device Z00, a presence or absence of user contact with the electronic device Z00, an orientation or an acceleration/deceleration of the electronic device Z00, and a change in temperature of the electronic device Z00. The sensor component Z14 may include a proximity sensor configured to detect the presence of nearby objects without any physical contact. The sensor component Z14 may also include a light sensor, such as a CMOS or CCD image sensor, for use in imaging applications. In some embodiments, the sensor component Z14 may also include an accelerometer sensor, a gyroscope sensor, a magnetic sensor, a pressure sensor, or a temperature sensor.

The communication component Z16 is configured to facilitate communication, wired or wirelessly, between the electronic device Z00 and other devices. The electronic device Z00 may access a wireless network based on a communication standard, such as Wi-Fi, operator networks (2G, 3G, 4G, or 5G), or a combination thereof. In some embodiments, the communication component Z16 receives a broadcast signal or broadcast associated information from an external broadcast management system via a broadcast channel In some embodiments, the communication component Z16 further includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In some embodiments, the electronic device Z00 may be implemented with one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components, to perform:

displaying a melody configuration page;

acquiring melody attribute information selected based on the melody configuration page;

displaying a melody generation button in a triggerable state on the melody configuration page in response to selection of the melody attribute information being completed;

displaying a candidate melody page in response to a triggering operation on the melody generation button, wherein the candidate melody page displays at least one candidate melody that matches the melody attribute information; and

determining one or more selected candidate melodies from the at least one candidate melody as a target melody.

In some embodiments, a non-transitory computer-readable storage medium including at least one instruction is further provided. For example, the memory Z04 including at least one instruction. The at least one instruction may be executed by the processor Z20 in the electronic device Z00 to achieve the above methods. For example, the non-transitory computer-readable storage medium may be a ROM, a RAM, a CD-ROM, a magnetic tape, a floppy disc, an optical data storage device, and the like.

In some embodiments, a computer program product is further provided. The computer program product includes a computer program including at least one instruction. The at least one instruction, when loaded and executed by a processor, causes the processor to perform:

displaying a melody configuration page;

acquiring melody attribute information selected based on the melody configuration page;

displaying a melody generation button in a triggerable state on the melody configuration page in response to selection of the melody attribute information being completed;

displaying a candidate melody page in response to a triggering operation on the melody generation button, wherein the candidate melody page displays at least one candidate melody that matches the melody attribute information; and

determining one or more selected candidate melodies from the at least one candidate melody as a target melody.

Each embodiment of the present disclosure may be executed individually or in combination with other embodiments, both of which fall within the protection scope of the present disclosure.

What is claimed is:

1. A method for generating a song melody, comprising:
displaying a melody configuration page;
acquiring melody attribute information selected based on the melody configuration page;
displaying a melody generation button in a triggerable state on the melody configuration page in response to selection of the melody attribute information being completed;
displaying a candidate melody page in response to a triggering operation on the melody generation button, wherein the candidate melody page displays at least one candidate melody that matches the melody attribute information; and
determining one or more selected candidate melodies from the at least one candidate melody as a target melody.

2. The method according to claim 1, wherein a song theme is displayed on the melody configuration page; and displaying the candidate melody page in response to the triggering operation on the melody generation button comprises:
acquiring, in response to the triggering operation on the melody generation button, at least one candidate melody that matches both the song theme and the melody attribute information; and
displaying the candidate melody page.

3. The method according to claim 1, wherein the candidate melody page comprises at least one subpage in one-to-one correspondence with the at least one candidate melody; and
displaying the candidate melody page comprises:
displaying a subpage of a first candidate melody on the candidate melody page.

4. The method according to claim 3, further comprising:
displaying, in response to a switching operation on the subpage of the first candidate melody, a subpage of a second candidate melody adjacent to the subpage of the first candidate melody.

5. The method according to claim 4, further comprising:
displaying a sliding prompt bar on the candidate melody page; and
controlling the sliding prompt bar to slide in a switching direction of the switching operation in response to the switching operation on the subpage of the first candidate melody.

6. The method according to claim 1, further comprising:
displaying a melody determination button on the candidate melody page; and
determining a selected candidate melody as the target melody in response to a triggering operation on the melody determination button.

7. The method according to claim 1, wherein the melody configuration page comprises a plurality of melody attributes and attribute selection controls corresponding to the melody attributes; and
acquiring the melody attribute information selected based on the melody configuration page comprises:
acquiring melody attribute information corresponding to the melody attribute in response to a triggering operation on the attribute selection control corresponding to the melody attribute.

8. The method according to claim 1, wherein displaying the candidate melody page in response to the triggering operation on the melody generation button comprises:
displaying a generation progress page in response to the triggering operation on the melody generation button;
displaying a generation progress of the at least one candidate melody on the generation progress page; and
displaying the candidate melody page in response to the generation progress indicating a completion.

9. The method according to claim 1, further comprising:
acquiring at least one candidate lyric corresponding to the at least one candidate melody in response to the triggering operation on the melody generation button; and
displaying the at least one candidate lyric on the candidate melody page.

10. An electronic device, comprising:
at least one processor; and
a volatile or nonvolatile memory configured to store at least one instruction executable by the processor,
wherein the at least one processor, when executing the at least one instruction, is caused to perform:
displaying a melody configuration page;
acquiring melody attribute information selected based on the melody configuration page;
displaying a melody generation button in a triggerable state on the melody configuration page in response to selection of the melody attribute information being completed;
displaying a candidate melody page in response to a triggering operation on the melody generation button, wherein the candidate melody page displays at least one candidate melody that matches the melody attribute information; and
determining one or more selected candidate melodies from the at least one candidate melody as a target melody.

11. The electronic device according to claim 10, wherein a song theme is displayed on the melody configuration page; and the at least one processor, when executing the at least one instruction, is caused to perform:
acquiring, in response to the triggering operation on the melody generation button, at least one candidate melody that matches both the song theme and the melody attribute information; and
displaying the candidate melody page.

12. The electronic device according to claim 10, wherein the candidate melody page comprises at least one subpage in one-to-one correspondence with the at least one candidate melody; and the at least one processor, when executing the at least one instruction, is caused to perform:
displaying the candidate melody page comprises:
displaying a subpage of a first candidate melody on the candidate melody page.

13. The electronic device according to claim 12, wherein the at least one processor, when executing the at least one instruction, is caused to perform:
displaying, in response to a switching operation on the subpage of the first candidate melody, a subpage of a second candidate melody adjacent to the subpage of the first candidate melody.

14. The electronic device according to claim 13, wherein the at least one processor, when executing the at least one instruction, is caused to perform:
displaying a sliding prompt bar on the candidate melody page; and
controlling the sliding prompt bar to slide in a switching direction of the switching operation in response to the switching operation on the subpage of the first candidate melody.

15. The electronic device according to claim 10, wherein the at least one processor, when executing the at least one instruction, is caused to perform:
displaying a melody determination button on the candidate melody page; and
determining a selected candidate melody as the target melody in response to a triggering operation on the melody determination button.

16. The electronic device according to claim 10, wherein the melody configuration page comprises a plurality of melody attributes and attribute selection controls corresponding to the melody attributes; and
the at least one processor, when executing the at least one instruction, is caused to perform:
acquiring melody attribute information corresponding to the melody attribute in response to a triggering operation on an attribute selection control corresponding to the melody attribute.

17. The electronic device according to claim 10, wherein the at least one processor, when executing the at least one instruction, is caused to perform:
displaying a generation progress page in response to the triggering operation on the melody generation button;
displaying a generation progress of the at least one candidate melody on the generation progress page; and
displaying the candidate melody page in response to the generation progress indicating a completion.

18. The electronic device according to claim 10, wherein the at least one processor, when executing the at least one instruction, is caused to perform:
acquiring at least one candidate lyric corresponding to the at least one candidate melody in response to the triggering operation on the melody generation button; and
displaying the at least one candidate lyric on the candidate melody page.

19. A non-transitory computer-readable storage medium storing at least one instruction therein, wherein the at least one instruction, when loaded and executed by a processor of an electronic device, causes the electronic device to perform:
displaying a melody configuration page;
acquiring melody attribute information selected based on the melody configuration page;
displaying a melody generation button in a triggerable state on the melody configuration page in response to selection of the melody attribute information being completed;
displaying a candidate melody page in response to a triggering operation on the melody generation button, wherein the candidate melody page displays at least one candidate melody that matches the melody attribute information; and
determining one or more selected candidate melodies from the at least one candidate melody as a target melody.
